(19) United States
(12) Patent Application Publication
(10) Pub. No.: US 2007/0143228 A1
(43) Pub. Date: Jun. 21, 2007

(54) Licensing matrix

(75) Inventors: Michael P. Jorden, Redmond, WA (US); Aidan T. Hughes, Bellevue, WA (US); R. David Chicks, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/303,200

(22) Filed: Dec. 15, 2005

(51) Int. Cl. G06Q 99/00

(52) U.S. Cl. 705/71

(57) ABSTRACT

A licensing system provides for enabling and disabling features based on the product key included with a software product. A distribution channel associated with the software product is identified. The distribution channel is identified according to a channel ID obtained from the product key. A set of default features associated with the application is also identified. The set of default features are modified to produce a new set of features for the application when the channel ID is associated with a modifier. The new set of features is applied to the software product such that a use experience and features of the software product is controlled by the product key.

### BACKGROUND

Product activation is a license validation procedure required by some computer software programs. Product activation is used to invalidate or severely restrict a product's functionality until the product is registered with a publisher by means of a special identification (activation) code or “product key”. Product activation often refers to a method where a software application or suite hashes hardware serial numbers and an ID number specific to the product's license (e.g., the product key) to generate a unique installation ID. The installation ID is sent to the manufacturer to verify the authenticity of the product key and determine that the product key is not being used for multiple installations. Other product key models are also used to enforce the purchase of a license for use of the software product.

Products may also have various activation states. An “un-activated” product usually acts as a time-limited trial until a product key is purchased. An “activated” product has its product key purchased and entered. Some products allow licenses to be transferred from one machine to another without deactivating the copy on the old machine before reactivating the software product on the new machine.

Most installation programs display a “custom setup” dialog box at run time, from which the end user can select which features to install or remove. Usually, the licensor of the software product or software suite that defines the available product features. Whatever has been selected as the features for that particular product, are the features that are presented to the user as available features for the software product or suite.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the subject matter disclosed herein are related to providing a licensing matrix that allows the available product features to be changed based on the product key associated with the software product. The licensing matrix is a conceptual data structure that provides for determining the intersection between a version of the software product and a distribution channel of the software product. A channel ID of the software product may be determined from the product key. A range of channel IDs is associated with each distribution channel. A particular range of channel IDs may have an associated modifier to the features of the software product. A software product with a channel ID that falls within that range has its features modified according to the modifier associated with the range. Therefore, a user may be presented with a different use experience for the software product for different product keys due to the differentiation between features that depend on the product key.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention as claimed.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates an exemplary computing architecture for a computer;

FIG. 2 illustrates a functional block diagram of an exemplary system for product key entry;

FIG. 3 illustrates an exemplary DPC file;

FIG. 4 illustrates an example parsing of the product key;

FIG. 5 illustrates an exemplary licensing matrix; and

FIG. 6 illustrates an operational flow diagram of an exemplary process for determining an applicable feature set for a software product according to its product key, in accordance with the present disclosure.

### DETAILED DESCRIPTION

Embodiments are herein described more fully below with reference to the accompanying drawings, which form a part hereof, and which show specific examples for practicing the embodiments. However, embodiments may be implemented in many different forms and should not be construed as limited to the embodiments set forth herein; rather, these embodiments are provided so that this disclosure will be thorough and complete, and will fully convey the scope of the subject matter to those skilled in the art. Embodiments disclosed may be practiced as methods, systems or devices. Accordingly, embodiments disclosed may take the form of an entirely hardware implementation, an entirely software implementation or an implementation combining software and hardware aspects. The following detailed description is, therefore, not to be taken in a limiting sense.

When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments of the described herein are referred to variously as operations, structural devices, acts or modules. These operations, structural devices, acts and modules may be implemented in software, in firmware, in special purpose digital logic, and any combination thereof.

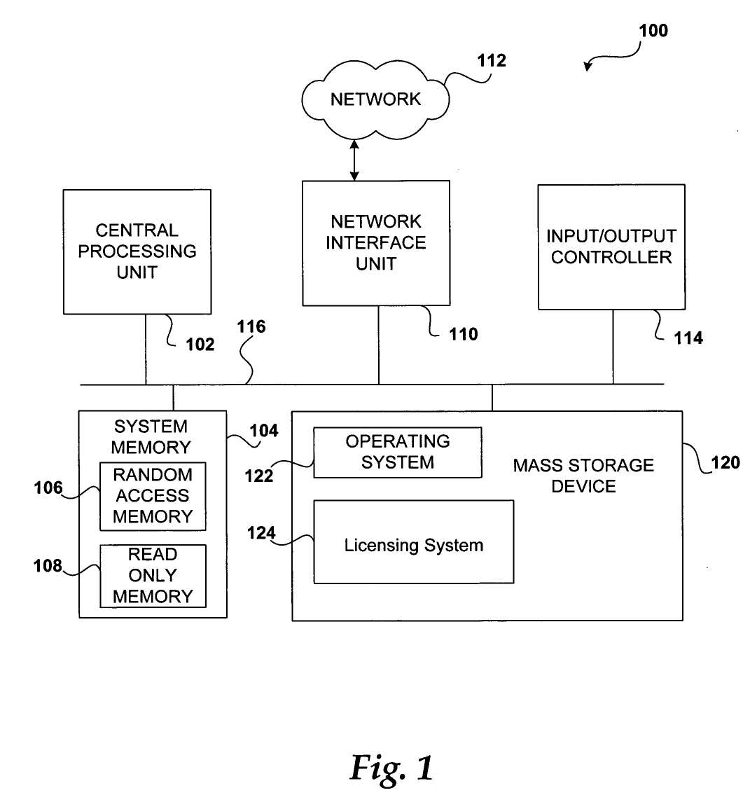

Referring now to the drawings, in which like numerals represent like elements, various aspects of the present invention will be described. In particular, FIG. 1 and the corresponding discussion are intended to provide a brief, general description of a suitable computing environment in which embodiments of the invention may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an exemplary computer architecture for a computing device 100 utilized in various embodiments will be described. The computer architecture shown in FIG. 1 may be configured in many different ways. For example, the computer may be configured as a personal computer, a mobile computer and the like. As shown, computing device 100 includes a central processing unit 102 (“CPU”), a system memory 104, including a random access memory 106 (“RAM”) and a read-only memory (“ROM”) 108, and a system bus 116 that couples the memory to the CPU 102. A basic input/output system containing the basic routines that help to transfer information between elements within the computer, such as during startup, is stored in the ROM 108. The computing device 100 further includes a mass storage device 120 for storing an operating system 122, application programs, and other program modules, which will be described in greater detail below.

The mass storage device 120 is connected to the CPU 102 through a mass storage controller (not shown) connected to the bus 116. The mass storage device 120 and its associated computer-readable media provide non-volatile storage for the computing device 100. Although the description of computer-readable media contained herein refers to a mass storage device, such as a hard disk or CD-ROM drive, the computer-readable media can be any available media that can be accessed by the computing device 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computing device 100.

According to various embodiments, the computer 100 operates in a networked environment using logical connections to remote computers through a network 112, such as the Internet. The computer 100 may connect to the network 112 through a network interface unit 110 connected to the bus 116. The network interface unit 110 may also be utilized to connect to other types of networks and remote computer systems.

The computing device 100 may also include an input/output controller 114 for receiving and processing input from a number of devices, such as: a keyboard, mouse, electronic stylus and the like. Similarly, the input/output controller 114 may provide output to a display screen, a printer, or some other type of device (not shown).

As mentioned briefly above, a number of program modules and data files may be stored in the mass storage device 120 and RAM 106 of the computing device 100, including an operating system 122 suitable for controlling the operation of a networked computer, such as: the WINDOWS XP® operating system from MICROSOFT® CORPORATION; UNIX®; LINUX® and the like. The mass storage device 120 and RAM 106 may also store one or more program modules. In particular, the mass storage device 120 and the RAM 106 may store a licensing system 124.

As described herein, licensing system 124 presents a selected group of features for a software product depending on a selected product key used in association with the software product.

Throughout the specification and claims, the following terms take the meanings explicitly associated herein, unless the context clearly dictates otherwise.

“Channel ID” is generally defined as a number that identifies the distribution channel through which a software product is delivered. For example, the software product may be delivered through an enterprise channel, where the software product is marketed to companies and other organizations. The software product may also be distributed through an OEM channel, where the software product is pre-installed on computing devices that are then sold to customers. The software product may also be distributed through a retail channel, where the software product is delivered to stores. Other channels may also be associated with a selected channel ID.

“Channel range” generally refers to distribution of channel IDs. For example, instead of being associated with one channel ID, a distribution of channel IDs may be used for software products delivered through a particular channel. For example, the retail channel may be associated with channel IDs 640-699, so that any software product that has a channel ID within that range is a software product delivered through the retail channel of distribution.

“Feature” generally refers a specific part of a software product that may be enabled or disabled. In one embodiment, different features for the same software product result in different SKUs applicable to each version of the software product. This definition for feature is separate and distinct from the definition of feature used with most installer programs. It is this definition, rather than the definition used in association with installer programs, that is the definition applicable throughout the specification and the claims for the term “feature”.

“DPC file” or “licensing file” is generally defined as a file that contains stored licensing information for a particular software product. For example, the DPC file may include information that identifies which features are enabled or disabled for a particular software product. In one embodiment, each DPC file is associated with a particular SKU (Stock Keeping Unit) that identifies the software product.

“Privilege” or “privilege level” generally refers to whether a specific feature is enabled or disabled for a specific version of the software product. For example, a word processor application has “printing privilege” because a printing feature is enabled for the word processor application.

“Product key” is generally defined as the activation code that is entered to activate a particular version of a software product. As described herein, depending on the product key used, certain features of the software product are enabled or disabled. This allows the same build of the software product to be sold, but presents the software product differently to a consumer based on the product key.

“SKU” or “Stock Keeping Unit” generally refers to a unique identifier for a version of a purchasable product. For example, a full, retail, packaged, English version of a software suite may have its own associated SKU. In one embodiment, the SKU is a result of combining the product, the language, and the channel range in order to uniquely identify that product version (e.g., “OEM professional English”, “retail, French, standalone”, “bypass, Japanese, word processor”, etc.).

“Software product” generally refers to the software application or suite of software applications that are sold as a purchasable package whether on a physical storage medium or through a purchased network download. For example, a word processor application may be sold by itself and be a single software product. Additionally, the same word processor application may be sold in combination with a spreadsheet application, and be another software product. In still another embodiment, an update to an existing software product may be its own software product. In accordance with an additional embodiment, a software product is any purchasable product that is associated with a particular SKU.

“Use experience” generally refers to the experience that a user has when interacting with a particular application. The use experience of the application is said to have changed when any user interface element, action, or other element of the application has changed.

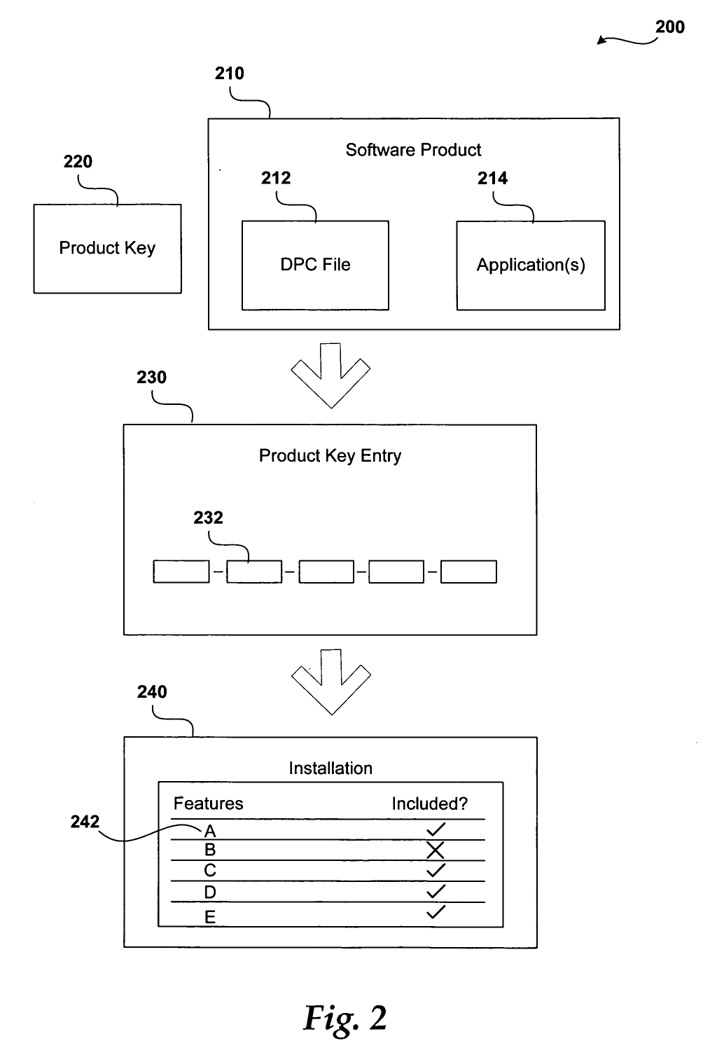

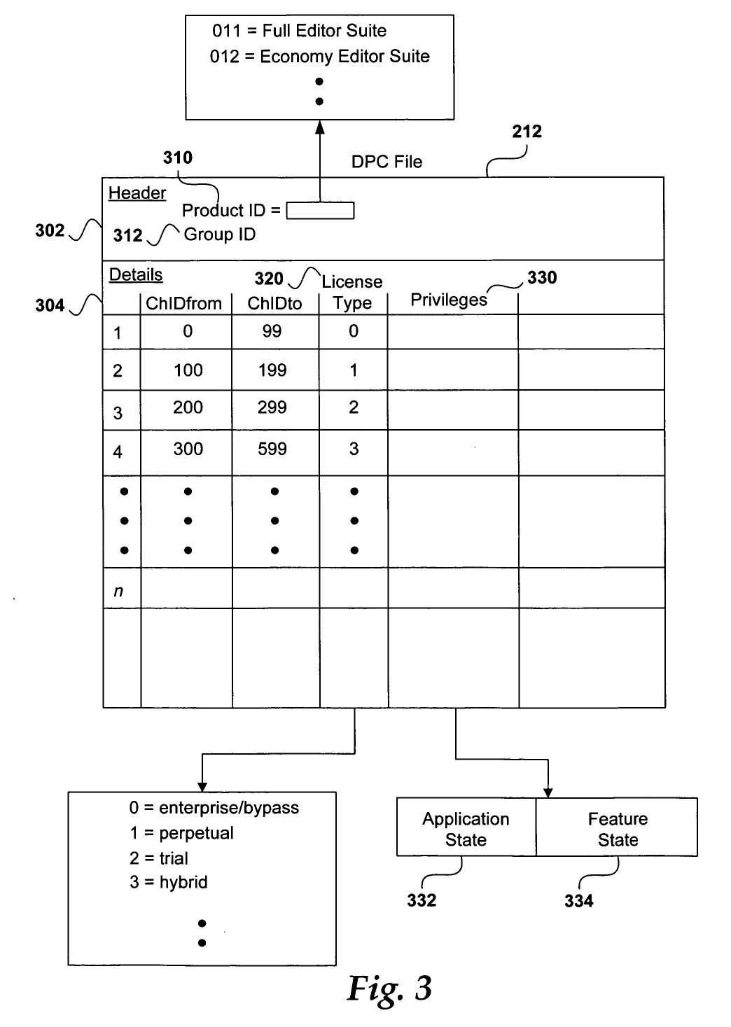

FIG. 2 illustrates a functional block diagram of an exemplary system 200 for product key entry, in accordance with the present disclosure. System 200 includes software product 210 and an associated product key 220. Software product 210 includes a DPC file 212 and one or more applications 214 that are included in the software product. Software product 210 may include applications that are part of suite that may be installed as a combination or individually. DPC file 212 is described in greater detail in the discussion of FIG. 3 below.

When software product 210 is loaded onto a computing device (e.g., computing device 100 of FIG. 1), product key entry window 230 is launched. Product key entry window 230 provides a dialog and instructions for entering product key 220. In one embodiment, product key 220 is provided as a label on packaging included with software product 210. In another embodiment, product key 220 is printed on the media containing software product 210. In still other embodiments, product key 220 is provided as part of a download, or electronically to a user for entry. In one embodiment, product key entry window 230 includes entry modules, similar to entry modules 232, for entering product key 220.

When product key 220 is entered correctly, some embodiments described herein provide installation window 240 that lists the features (e.g., 242) of software product 210 that will be installed. For the subject matter herein described, the features (e.g., 242) that are to be installed depend from what is entered for product key 220 rather than what is included as data related to applications 214 in software product 210. Previously, for features (e.g., 242) to be included or excluded from a version of a software product, those features were excluded or included on the copy of the software product provided to the user. In contrast, system 200 instead provides the same version of the software product on each copy of the product, whether provided over a network or on a physical storage media, and differentiates the features among versions according to product key 220. The differentiation among provided features is supplied through information included product key 220 and DPC file 212, as described in greater detail below.

FIG. 3 illustrates an exemplary DPC file in accordance with the present invention. DPC file 212 corresponds to the DPC file associated with software product 210 illustrated in FIG. 2. In the embodiment shown, DPC file 212 includes header section 302 and details section 304.

In the example shown, header section 302 includes data about the associated software product (e.g., software product 210 of FIG. 2). Header section 302 includes product ID 310 and group ID 312. In one embodiment, product ID 310 corresponds to a three digit number that identifies the software product associated with the DPC file. For example, the product ID may be “011” and correspond to a full editor suite of the software.

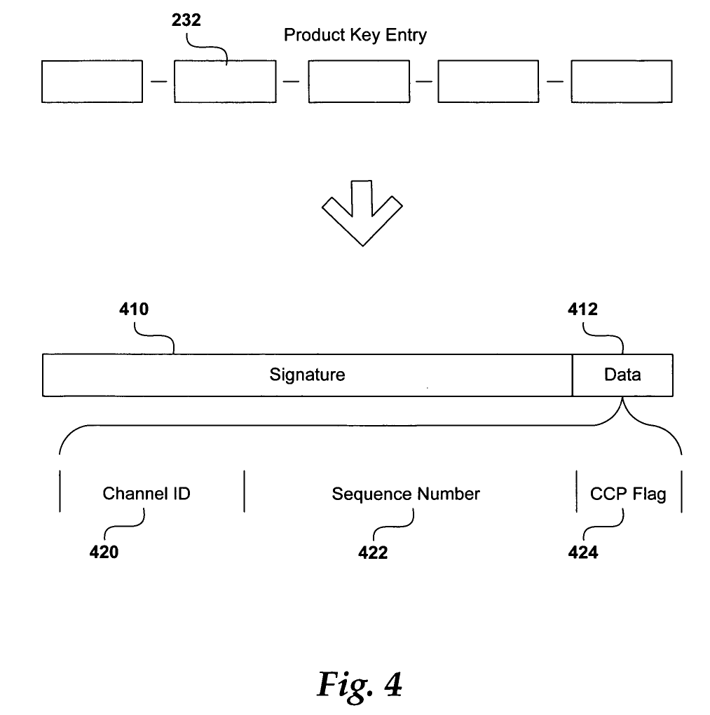

Group ID 312 is generated from an analysis of the product key included with the software product. Turning briefly to FIG. 4, illustrated is an example parsing of the product key, in accordance with the present disclosure. In the example shown, product key 220 is entered in according to product key entry module 232. The product key may be any key that allows for secure installation of the software product. Product key entry module 232 shown is separated into five sections (for ease of entry) of five characters each to form a twenty-five character product key. This product key may then be translated to a set of bits that includes signature 410 and data 412. In one embodiment, the product key is converted from the alpha-numeric characters into binary. The twenty-five characters translate into 114 bits that then comprise signature 410 (83 bits) and data 412 (31 bits). However, the structure of the product key or its translation is not essential for the practice of the embodiments described herein.

In one embodiment, signature 410 is generated using public/private key cryptography, with signature 410 being generated from a private key. Part of signature 410 is a hash of data 412 using a private key of a private key/public key pair. In this embodiment, when a software product is distributed, it is distributed with one of a range of public keys (e.g., public keys 116-117 correspond to word processor version 5). If the hash of data 412 is verified as being authentic according to one of these public keys, the product key entered is valid. When the comparison is made, one of the pieces of information retrieved is the private key ID (e.g., product X is valid with private key 116). Dividing the private key ID by a factor of 2 (e.g., % 2 of the private key ID) results in group ID 312. The remainder of the division (e.g., division of 117 by 2 results in a remainder of 1), is the OEM flag. The OEM flag is used to denote whether a software product is a retail/enterprise or OEM version. By parsing out the product key, a group ID (e.g., 312) is determined for the DPC file (e.g., 212).

Additional information may be derived from product key 220. Data 412 includes bits that identify a channel ID. In the example where a twenty-five character product key is used, the channel ID corresponds to 10 bits of the translated data. The 10 bits give roughly one thousand possible channel IDs. The channel ID delineates the distribution channel that the software product ships through and it is used to enable the different features of the product. For example, channel IDs in the range of 0-99 may correspond to enterprise bypass products, while channel IDs in the range of 100-199 correspond to perpetual versions of the software product, and channel IDs in the range of 200-299 represent trial versions of products. The bypass designation means that the software product need not be activated once it is installed, and perpetual refers to the software product needing to be activated only once. In contrast, trial versions of the product expire without being upgraded.

Turning back to FIG. 3, each record (e.g., 1−n) in the details section 304 includes the information for interpreting the channel ID depending on the range in which it falls. Each range of channel ID 420 corresponds to a particular license type 320. For example, channel IDs in the range of 0-99 may correspond to a license type of “0” which represents enterprise/bypass versions of the software product, while channel IDs in the range of 100-199 correspond to a license type of “1” which represents perpetual versions of the software product, and channel IDs in the range of 200-299 correspond to a license type of “2” which represents trial versions of the software product. Additionally, another license type may also be used (e.g., “3”) for a hybrid license type. When a software product has a channel ID that corresponds to a hybrid license type, the privileges column 330 is checked to determine the application state 332 for each application included in the software product. With the hybrid license type, some applications may be trial versions while others are perpetual or enterprise/bypass. These numbers for representing license type 320 are arbitrary as used herein, as well as are the ranges illustrated for channel ID 420.

Turning again to FIG. 4, data 412 produced by the product key 232, also includes sequence number 422. In one embodiment, sequence number 422 is twenty bits in length providing roughly one million possible combinations for sequence number 422. With a sequence number of this size, roughly one million product keys may be associated with each channel ID. Any size of sequence number may be used however, and implementations of the embodiments described herein are not limited to a sequence numbers of a particular length.

Data 412 also includes CCP flag 424. In one embodiment, CCP flag 424 is a single bit that is toggled to indicate whether the software product corresponds to an upgrade version or a release version of the software product.

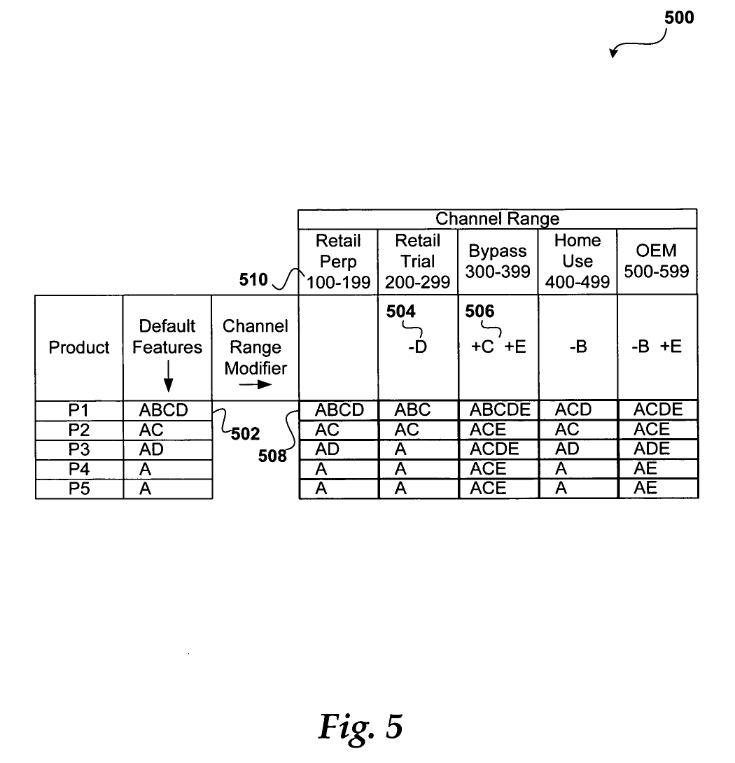

For determining the features that are available for the current version of the software product, privileges 330 is examined to determine the state of each feature or feature state 334. Another example for how the state of each feature is stored is described according to the licensing matrix 500 shown in FIG. 5 below.

FIG. 5 illustrates an exemplary licensing matrix in accordance with the present disclosure. Licensing matrix 500 includes data that may be included in a DPC file that describes the privileges level for each of the features of a software product. Example matrix 500 represents a software suite that includes five applications (P1-P5). Each of the five applications has an associate set of default features (e.g., 502). For example, application P1 has default features 502 of A, B, C, and D. Through the privilege information included in the DPC file, the feature set for each application may be changed according to the channel ID (i.e., distribution type) of the software product.

Licensing matrix 500 includes additional channel ID ranges (e.g., 510) than those previously described. For licensing matrix 500, the channel ID range of 100-199 corresponds to a retail perpetual version of the software product, channel ID range of 200-299 corresponds to a retail trial version, channel ID range 300-399 corresponds to a bypass or enterprise product, channel ID range 400-499 corresponds to a home use version of the software product, and channel ID range 500-599 corresponds to an OEM product.

For each of the channel ID ranges (e.g., 510), a channel range modifier (e.g., 504) may be included that changes the feature set of each application within the suite. For example, for the retail trial version of the software product a channel range modifier 504 of “−D” is included. Channel range modifier 504 therefore disables the feature D from any of the applications in the software product when the software product is a retail trial version. Since only applications P1 and P3 include D among their default set of features (e.g., 502), only these applications are affected by the modification. For example, product P1 has default features A, B, C, D. With the modifier to remove privilege D, the resultant or new feature set (e.g., 508) is A, B, C. In contrast, channel range modifier 506 enables features (i.e., privileges) C and E when the channel ID of the software suite falls within the range of 300-399 for a bypass product. Any combination of feature additions or subtractions may be used as a modifier to the feature set for product within the channel ID range specified. Additionally, any one of the modifications may represent a privilege level (e.g., privilege A) that actually affects a host of features rather than just a single feature of the software product.

In one embodiment, when the privileges are read from each DPC file, the privileges are combining according to a logical OR operation and the results are stored in a runtime list (not shown). The runtime list includes both the allowed and disallowed features according to the set of privileges that are obtained.

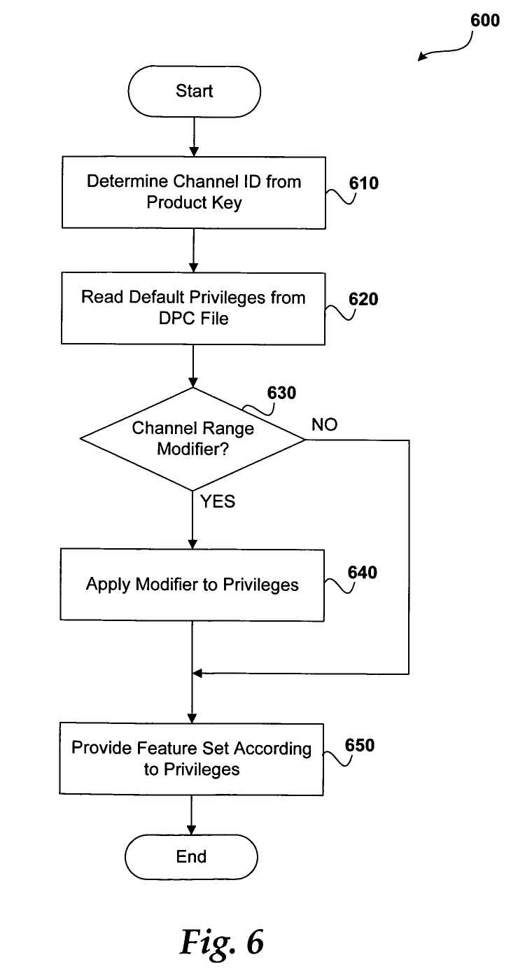

FIG. 6 illustrates an operational flow diagram of an exemplary process for determining an applicable feature set for a software product according to its product key, in accordance with the present disclosure. Process 600 begins when a user has selected to install a software application or suite on their computing device and has entered the product key. Processing continues with operation 610.

At operation 610, the licensing system determines the channel ID for the software product from the entered product key. The channel ID is included in the data resulting from converting the product key to binary data. As previously stated, the channel ID falls within a range of channel IDs that represent a distribution channel for the software product. Once the channel ID is determined, processing continues with operation 620.

At operation 620, the default privileges associated with the software product are read from the DPC file associated with that particular product. More than one DPC file may be associated with each software product, with multiple DPC files included for suites of software applications. Once the default privileges of a particular application are read from the DPC file, processing continues with decision operation 630.

At decision operation 630, a determination is made whether a channel range modifier is associated with the channel range of the channel ID. For example, when a trial version of a product is used, certain privileges to access certain default features of the software product may be disabled. The channel range modifier provides the changes that disable these privileges. If no channel range modifier is associated with the channel ID according to its channel ID range, processing advances to operation 650. However, if the channel ID range of the channel ID for the software product does have an associated channel range modifier, processing continues with operation 640.

At operation 640, the modifications indicated by the channel range modifier are applied to the privileges of the software product. For example, privileges may be added or removed depending on the version of the software product and the distribution channel of the software product. The privilege level therefore represents an intersection between the version of the software and the channel ID range within a matrix. Once the modification is applied, processing continues with operation 650.

At operation 650, the privileges determined for a particular software product are applied to the product. In one embodiment, a features set dialog or installation window (e.g., 240) is provided to a user that indicates the activated feature set for this software product. Once the privileges are applied to the software product, process 600 ends and processing moves to other tasks.

Process 600 may be repeated for each application being installed. More than one application may be installed for a particular software product, and a particular DPC file may be associated with one or more of these applications. By providing the feature set according to the product key, a storage medium (e.g., a CD-ROM) may be loaded with an expansive copy of the software applications to be installed, and then the features of the software application are selected by the product key. This allows for a single build of the product on the storage medium and a simple interchange of the product key, rather than having to build and store each version of the software product separately (e.g., trial version generated separate from perpetual, etc.). Therefore with a single CD a use experience may be presented with different versions of the applications depending on the product key included with the software product.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. One or more computer-readable media including computer-executable instructions thereon for enabling and disabling features of an application included in a software product according to a product key, comprising:
identifying a distribution channel associated with the software product, wherein the distribution channel is identified according to a channel ID obtained from the product key;
identifying a set of default features associated with the application;
modifying the set of default features to produce a new set of features for the application when the channel ID is associated with a modifier; and
applying the new set of features to the software product such that a use experience with the software product is controlled by the product key.

2. The one or more computer-readable media of claim 1, wherein obtaining the channel ID from the product key further comprises converting the product key to binary data that includes the channel ID.

3. The one or more computer-readable media of claim 1, wherein the computer-executable instructions further comprise generating a matrix for determining the new set of features.

4. The one or more computer-readable media of claim 3, wherein an intersection within the matrix between a version associated with the application and the distribution channel corresponding to the channel ID, identifies the new set of features.

5. The one or more computer-readable media of claim 3, wherein the distribution channel is represented by a selected range of channel IDs.

6. The one or more computer-readable media of claim 1, wherein the set of default features is used for the use experience when a modifier is not associated with the channel ID.

7. The one or more computer-readable media of claim 1, wherein a feature state is associated each feature of the application, the feature state corresponding to whether a feature is enabled or disabled based on the product key provided.

8. The one or more computer-readable media of claim 1, wherein identifying a distribution channel associated with the software product further comprises obtaining the set of default features from a DPC file.

9. The one or more computer-readable media of claim 1, wherein the DPC file identifies the software product according to a product ID.

10. A licensing system, comprising:
an application that is available for installation onto a computing device, wherein the application is included in a software product;
a licensing file included in the software product, the licensing file comprising an identifier of the software product, detail data for identifying a distribution channel associated with the software product, and privileges associated with the application; and
a product key that is associated with the software product, wherein the product key provides a channel ID when the product key is entered, the channel ID identifying the distribution channel of the software product such that the privileges applied to the application are modified when indicated by the product key.

11. The licensing system of claim 10, wherein the privileges applied to the application affect a use experience for the application, such that the use experience is determined by the product key.

12. The licensing system of claim 10, wherein the detail data for identifying a distribution channel associated with the software product is associated with a channel range, the change range identifying a range of channel IDs that are associated with the distribution channel.

13. The licensing system of claim 12, wherein the privileges applied to the application are modified when a channel range modifier is associated with the channel range.

14. The licensing system of claim 13, wherein the channel range modifier provides at least one of a feature to enable for the application and a feature to disable for the application.

15. The licensing system of claim 10, wherein the distribution channel corresponds to at least one of the following: a retail channel that distributes a trial version of the software product; a retail channel that distributes a perpetual version of the software product, a bypass channel that distributes an enterprise version of the software product, a retail channel that distributes a home use version of the software product, and an OEM channel that distributes an OEM version of the software product.

16. The licensing system of claim 10, wherein when the product key is entered, the product key is parsed to produce the channel ID.

17. The licensing system of claim 16, wherein the product key is parsed using private/public key cryptography.

18. A computer-implemented method for enabling and disabling features of an application included in a software product according to a product key, comprising:
parsing the product key to obtain a channel ID;
identifying a set of default features associated with the application, wherein the set of default features are obtained from a licensing file;
constructing a matrix that identifies a new set of features for the application, wherein the new set of features represent the intersection between the channel ID and an identifier of the application;
modifying the set of default features to produce the new set of features for the application when the channel ID is associated with a modifier; and
applying the new set of features to the software product such that a use experience with the software product is controlled by the product key.

19. The computer-implemented method of claim 18, wherein the new set of features is the same as the set of default features when a modifier is not associated with the channel ID.

20. The computer-implemented method of claim 18, wherein the channel ID is included in a range of channel IDs, wherein the range of channel IDs includes the modifier when the version of the software product indicates that the use experience for the software product according to its product key is different from a use experience provided according to the set of default features.
